(19) United States
(12) Patent Application Publication
(10) Pub. No.: US 2017/0083695 A1
(43) Pub. Date: Mar. 23, 2017

(54) METHOD FOR USING EYE TRACKING AND EYE BIOMETRICS FOR AUTHENTICATION

(71) Applicant: The Eye Tribe Aps, Copenhagen S (DK)

(72) Inventors: Javier San Agustin, Copenhagen (DK); Jonas Philip Priesum, Copenhagen (DK)

(73) Assignee: The Eye Tribe, Copenhagen (DK)

(21) Appl. No.: 15/286,877

(22) Filed: Oct. 6, 2016

Related U.S. Application Data
(60) Provisional application No. 62/221,225, filed on Sep. 21, 2015.

(51) Int. Cl. G06F 21/32; G06F 3/01

(52) U.S. Cl. CPC G06F 21/32; G06F 3/013

(57) ABSTRACT

The invention is a method for authenticating a system user based on eye tracking or eye parameters.

### TECHNICAL FIELD

The present invention relates to user authentication based on eye tracking and eye biometrics.

### BACKGROUND OF THE INVENTION

There is an indisputable trend where people are using handheld devices for communications, information access, financial transactions, and more. With tens of millions of smartphone systems in users' hands, these systems have become repositories for sensitive applications and data. As such, it is increasingly important the users feel secure that their systems will only operate under each user's control.

Many such systems now incorporate four-digit passcodes which allow operation only when someone enters the proper code. But, anyone can do so if the code is known. Fingerprint authentication subsystems and methods are also in limited use. With these, the user swipes a fingertip over a sensor and if the fingerprint matches a previously stored one, the user is authenticated and now able to operate the system.

### BRIEF SUMMARY OF THE INVENTION

The invention disclosed and claimed is a method for using eye tracking or eye parameters as a way to authenticate a user's access to a system either alone or in combination with other authentication subsystems and methods.

With eye tracking, one would look at an image, and in particular, at a specific area the user has predefined as an unlocking area. When the gaze coordinates are found to coincide with the unlock area's coordinates, and the gaze is maintained for some interval of time, the system is unlocked.

In another embodiment, eye parameters are measured and stored for a user, and each time the system is used subsequently, new eye parameters are measured and compared. If the similarity between the initial stored parameters and the current parameters meet or exceed a threshold value, then the user is authenticated and operation of the system is enabled.

Either or both embodiments may be used in conjunction with other authentication methods, such as fingerprint matching, to provide a higher level of security.

### BRIEF DESCRIPTIONS OF THE DRAWINGS

FIG. 1 depicts a person holding a smartphone system and gazing at an unlock area.

FIG. 2 illustrates how a particular area of a screen image may be designated by the user as the unlock area, and when gazed at for some interval of time, will serve as an authentication

FIG. 3 is a flow diagram of one embodiment of the method whereby eye tracking and gaze coordinates are used to determine if a user is gazing at an unlock area.

FIG. 4 illustrates a sequence in which the user's system displays a locked screen image, followed by the user gazing at the unlock area, and the system then unlocks.

FIG. 5 illustrates a combinatorial authentication scheme where by eye tracking and fingerprint detection is used to authenticate.

FIG. 6 shows a variety of eye parameters that may be measured and stored based on light-source illumination and camera capture of various eye metrics.

FIG. 7 is a flow diagram of another embodiment of the method whereby eye parameters are captured and compared, and if the similarity is above some predetermined threshold, then the user is authenticated.

FIG. 8 illustrates a sequence in which the user's system displays a locked screen containing an unlock object, followed by the user gazing at the unlock object, and the system then unlocks.

### DETAILED DESCRIPTION OF THE INVENTION

With tens of millions of smartphones in use with many hosting sensitive applications and data, it is important for users to feel secure that their systems can only be operated under their control.

A common method for authentication is a four-digit passcode, such as 1 2 3 4, which the user predefines when setting up the system for the first time. Subsequent operation will require inputting that same passcode. However, anyone who knows that code can enter it and gain operational access.

Many laptop computers manufactured since 2005 are outfitted with fingerprint detection sensors and fingerprint matching authentication software. When initially setting up the computer, the user swipes his or her finger over the sensor and establishes the fingerprint data profile. Subsequent access and operation can be enabled by again swiping the same fingertip and having a match occur with the stored fingerprint profile.

Using eye tracking or eye parameter technologies, one can develop an alternative or combinatorial authentication method that can bolster the authentication security of any one method.

Eye tracking makes use of sensors to determine where someone is gazing. There are many eye tracking technologies available.

If a user makes use of eye tracking technology to first predefine an area of the screen as an unlock area; then subsequently using eye tracking technology, the system can determine if a user is gazing at the unlock area. In FIG. 1, the user by gazing at the area 101 can designate that area as the unlock area, and subsequently if the user gazes at area 101 for some period of time, the eye tracking technology can substantiate it and authenticate the user.

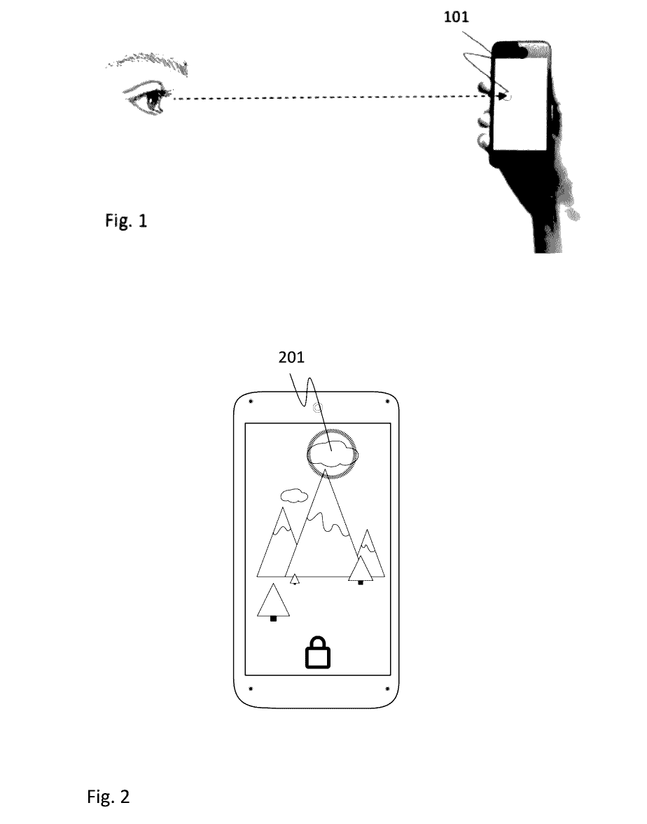

FIG. 2 illustrates a system with a display screen image where one area (e.g. the cloud) has been previously defined as the unlock area. When a user then gazes at the cloud for some minimal period of time, the eye tracking subsystem substantiates it and the system is then unlocked. Note that one can use gaze duration or a limit to the number of distinct gazes to mitigate attempts to establish authorization by someone other than the user.

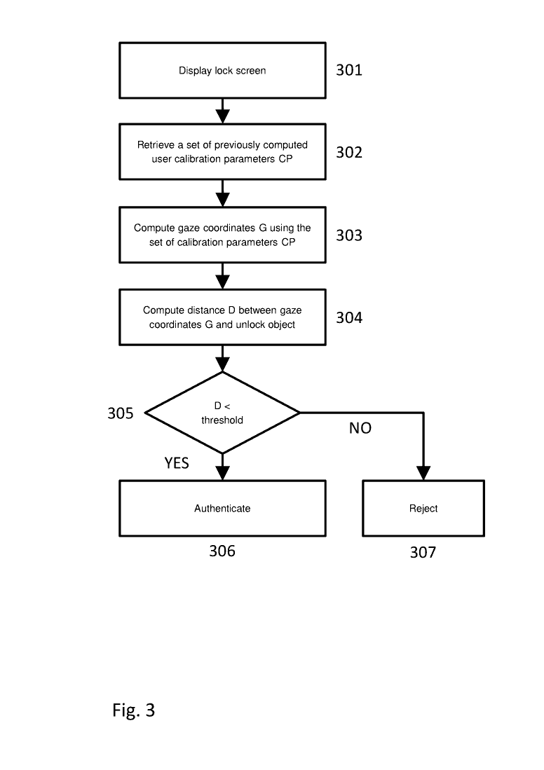

The flow diagram of FIG. 3 shows one embodiment of the method disclosed and claimed. After a display lock screen has been displayed (301), a set of previously measured and computed user calibration parameters, CP, are retrieved (302). The current user gaze coordinates are measured and computed using the CP data (303). From the gaze coordinates and predetermined unlock area coordinates the distance between the two is computed (304). The distance is compared to a threshold distance (305), and if less than the threshold value, the user is authenticated (306). If greater than the threshold value (307) the authentication is rejected.

The set of calibration parameters CP may include coefficients of regression equations, projective transformations, affine transformations, mappings between coordinate systems, or any combination of these.

The set of calibration parameters may be computed when the user sets up the device for the first time, that is, via a calibration procedure. In some embodiments, one or more calibration parameters may be computed and updated while the user uses the device, so that a set of recent calibration parameters is available for authentication.

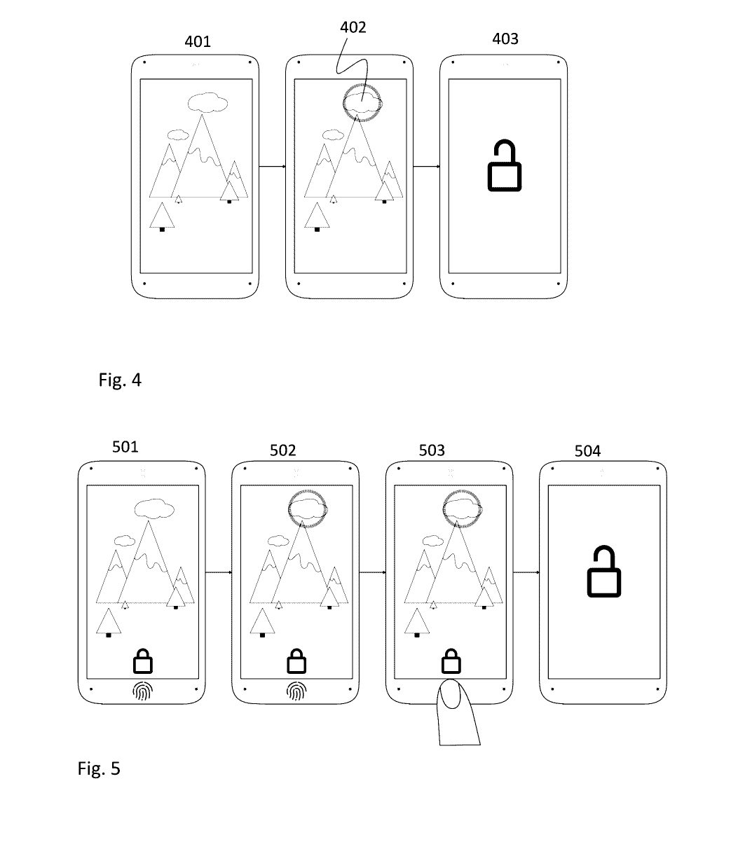

FIG. 4 shows a typical sequence in which the system with locked screen display (401) is gazed at such that the unlock area (402) is determined to be the gaze area and the system is unlocked (403).

FIG. 5 shows a similar sequence to FIG. 4 with the addition of fingerprint detection with eye tracking detection as the authentication method. Here the locked screen display is shown (501) followed by a gaze at the unlock area (502) followed by the swipe of a fingertip (503). The gaze and fingerprint detection may occur simultaneously, too. In that case, the system may compare gaze data to the unlock area only during the time while the fingertip is place on the scanner. This could prevent a malicious user from just looking around the screen until it unlocks. If the fingerprint matches the fingerprint data profile and the gaze area is determined to be the unlock area, then the system is unlocked (504).

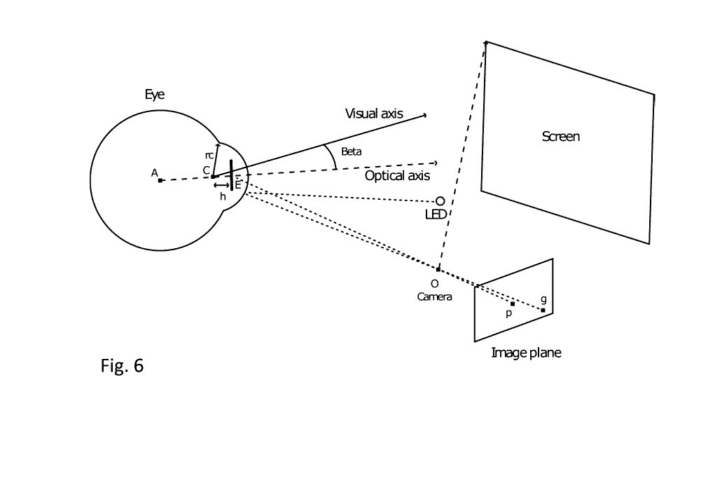

FIG. 6 illustrates some eye parameters that can be determined using one or more light sources and one or more cameras. The set of eye parameters could include the horizontal and vertical displacements between the optical axis and visual axis, which are designated as alpha and beta; it can also include the corneal radius, designated rc; it can also include the distance between cornea center and pupil center, designated h. The eye parameter data, like fingerprint data, is essentially unique to each individual. A system outfitted with light source, camera, and pertinent computational algorithms could measure, calculate, and store one or plurality of such eye parameters.

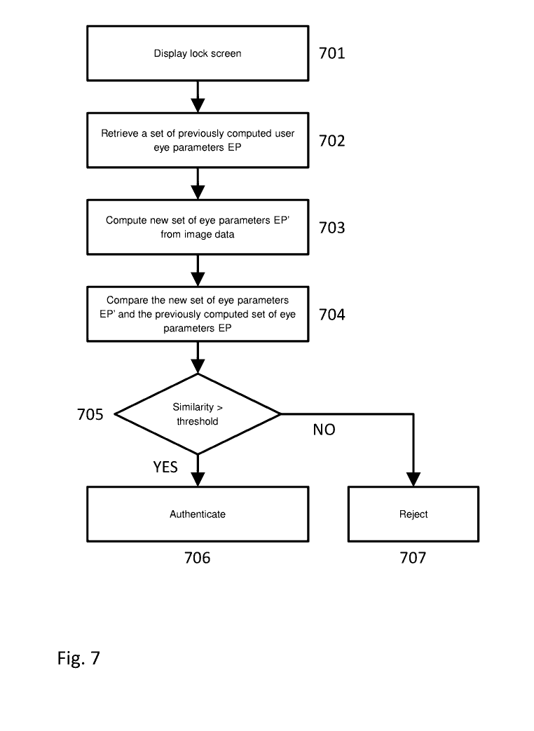

FIG. 7 shows another embodiment of the method whereby eye parameter data is used for authentication. First, a locked system display screen is displayed (701). A previously computed set of eye parameter data is retrieved (702). The current eye parameter data of a user is measured and computed (703). The current user eye parameter data is compared to the previously stored data (704). One way of comparing one set of eye parameters to another, for example, would be to use the Mahalanobis distance. The comparison value is compared to a predetermined similarity threshold value (705). If the similarity value exceeds the threshold value, the user is authenticated (706). If the similarity value is less than the threshold value, the authentication is rejected (707).

In some embodiments, multiple precomputed sets of eye parameter data belonging to different profiles are stored. The current user eye parameter data is compared to all the stored sets of eye parameter data, and a set of similarity values is calculated. If the similarity value with highest probability (e.g., the match with the shortest Mahalanobis distance) exceeds a predetermined similarity threshold value, the user is authenticated as the profile with the corresponding set of eye parameter data.

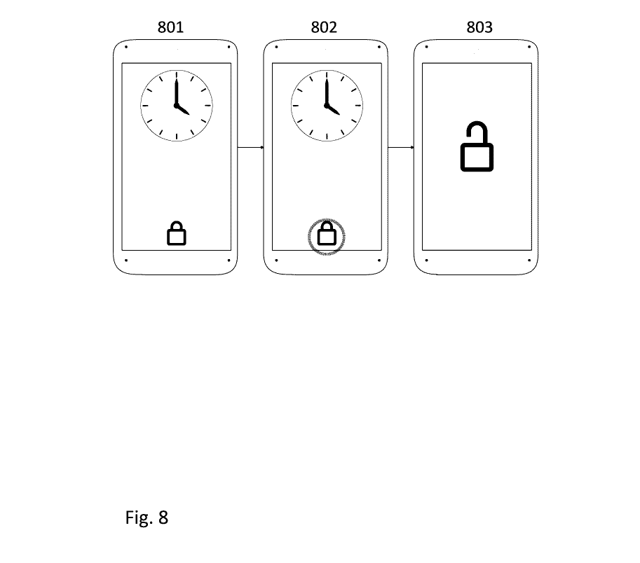

FIG. 8 shows a typical sequence in which the system with locked screen display (801) is gazed at. In particular, the unlock area (802), e.g. the lock icon, is gazed at. The system computes a set of current eye parameters, which are matched against the precomputed set of eye parameters, and the system is unlocked (803).

The set of eye parameters may be computed when the user sets up the device for the first time, that is, via a calibration procedure. In some embodiments, one or more eye parameters may be computed and updated while the user uses the device, so that an optimal set of eye parameters for the user is available for authentication.

In some embodiments, the set of eye parameters may include eye movement information, for example, saccade information (saccade latency, velocity and acceleration profile, saccade duration, or any combination of these). Saccade information may be computed by having the user look at two consecutive unlock areas, and tracking the eye movement and velocity during the saccadic movement taking place between those locations.

Similarly, the set of eye parameters may include information about smooth pursuit movement. The system may compute the smooth pursuit movement information by having the unlock object move smoothly with predetermined movement parameters such as acceleration, velocity and direction. When the user tracks the movement of the unlock object, a smooth pursuit eye movement takes place.

What is claimed is:

1. A method comprising:
Retrieving a set of one or more pre-computed stored eye tracking calibration parameters;
Using said calibration parameters to determine a gaze area;
Calculating a distance between said gaze area and the unlock area of a display screen;
Comparing said distance to a predetermined threshold value.

2. A method as in claim 1, further comprising:
Authenticating and unlocking a system if said distance is less than said threshold value, and rejecting access otherwise.

3. A method as in claim 2 further comprising:
Determining whether a second authentication criterion has been met;
Keeping said system locked if said second authentication criterion has not been met.

4. A method as in claim 1 further comprising:
Computing one or more said eye tracking calibration parameters during a calibration procedure.

5. A method as in claim 1 further comprising:
Computing one or more said eye tracking calibration parameters during system use.

6. A method as in claim 1 further comprising:
Updating one or more said eye tracking calibration parameters after a successful authentication.

7. A method comprising:
Retrieving a set of one or more pre-computed stored user eye parameters;
Measuring current user eye parameters;
Comparing said stored eye parameters to said current user eye parameters;
Determining if said current user eye parameters match said stored eye parameters within a predetermined similarity threshold value.

8. A method as in claim 7 further comprising:
Authenticating and unlocking said system if said current user eye parameters equal or exceed said predetermined similarity threshold value, and rejecting access otherwise.

9. A method as in claim 8 further comprising:
Determining whether a second authentication criterion has been met;
Keeping said system locked if said second authentication criterion has not been met.

10. A method as in claim 7 further comprising:
Computing one or more said eye parameters during a calibration process.

11. A method as in claim 7 further comprising:
Computing one or more said eye parameters while the system is being used.

12. A method as in claim 7 further comprising:
Updating one or more said eye parameters are updated after a successful authentication of the user.
